(19) United States
(12) Patent Application Publication
(10) Pub. No.: US 2019/0318833 A1
(43) Pub. Date: Oct. 17, 2019

(54) METHODS FOR ENHANCING ANOMALOUS HEAT GENERATION

(71) Applicant: Industrial Heat, LLC, Raleigh, NC (US)

(72) Inventors: Joseph A. Murray, Raleigh, NC (US); Tushar Tank, Raleigh, NC (US); Melissa Brent Hill, Raleigh, NC (US)

(21) Appl. No.: 16/473,024

(22) PCT Filed: Dec. 22, 2017
(86) PCT No.: PCT/US2017/068100

§ 371 Date: Jun. 24, 2019

Related U.S. Application Data
(60) Provisional application No. 62/437,733, filed on Dec. 22, 2016.

(51) Int. Cl. G21B 3/00; B01J 19/24

(52) U.S. Cl. CPC G21B 3/002; B01J 2219/2453; B01J 2208/00309; B01J 19/249

(57) ABSTRACT

Methods and apparatus are disclosed for enhancing anomalous heat generation. An enriched transition metal such as palladium, nickel, zirconium, or ruthenium has a different isotopic composition than the naturally occurring distribution. One or more isotopes of a transition metal are enriched and the concentration of these isotopes is higher than the natural abundance. The enriched transition metal may form metal oxide. It is disclosed herein that plating a reaction chamber with an enriched transition metal or metal oxide having a specific composition improves heat generation in an exothermic reaction.

### CROSS-REFERENCE TO RELATED APPLICATION

This application is a U.S. National Stage application of International Application No. PCT/US17/068100, filed on Dec. 22, 2017, which claims priority to U.S. provisional patent application No. 62/437,733, titled “Methods for Enhancing Anomalous Heat Generation,” filed on Dec. 22, 2016, which is incorporated herein in its entirety by this reference.

### TECHNICAL FIELD

The present disclosure relates generally to heat generation, and more specifically, to enhancing anomalous heat generation using enriched transition metal isotopes.

### BACKGROUND

For decades, scientists have been searching for alternative energy sources to replace fossil fuels and nuclear power. Over the past thirty years, scientists have, on many occasions, observed the phenomenon of excess heat being generated when hydrogen/deuterium gas is loaded into a transition metal or a metal alloy, for example, transition metals or metal alloys of palladium, nickel, or platinum. The observed excess heat generated during hydrogen/deuterium loading is often attributed to the fusion reaction between two deuterium nuclei that are trapped in the metal lattice. In one theory, two deuterium nuclei, when trapped in a metal lattice, will have a wide spread of momentum distribution based on the Heisenberg uncertainty principle. The combined probability of two deuterium nuclei having requisite momenta to overcome the Coulomb barrier may become statistically significant, triggering fusion reactions in the trapped deuterium gas. According to a second theory, the two trapped deuterium nuclei go through a quantum tunnel to reach the lower energy state, i.e., to form a ⁴He nucleus.

Although these experiments have been replicated around the world, efforts to generate excess heat in a consistent manner have not been successful. Scientists have explored different conditions in which generation of excess heat can be enhanced, but research in this field has largely been inconclusive.

### SUMMARY

The present disclosure relates to methods and apparatus for enhancing exothermic reactions for generating anomalous heat.

In some embodiments, an exothermic reaction between a hydrogen gas and a transition metal inside a reaction chamber is enhanced by plating the reaction chamber with an enriched product of the transition metal. The enriched product of the transition metal has an isotopic distribution that varies from the natural abundances of the stable metal isotopes. The high concentration of the isotope in the enriched product is achieved using centrifugal separation, foam fabrication, spin casting, electromagnetic calutron, laser separation, or other isotope enrichment techniques.

In one embodiment, the transition metal is palladium and one of the palladium isotopes, ¹⁰²Pd, ¹⁰⁴Pd, ¹⁰⁵Pd, ¹¹⁰Pd, has a higher concentration than its natural abundance.

In one embodiment, the transition metal is nickel and one of the nickel isotopes, ⁵⁸Ni, ⁶⁰Ni, ⁶¹Ni, ⁶²Ni, and ⁶⁴Ni, has a higher concentration than its natural abundance.

In one embodiment, the transition metal is zirconium and one or more of the zirconium isotopes, ⁹⁰Zr, ⁹¹Zr ⁹²Zr, ⁹⁴Zr, and ⁹⁶Zr, have a higher concentration than its natural abundance.

In one embodiment, the transition metal is ruthenium and one or more of the ruthenium isotopes, 96Ru, 98Ru, 99Ru, 100Ru, 101Ru, and 104Ru, have a higher concentration than its natural abundance.

In some embodiments, the enriched product of the transition metal comprises two isotopes whose concentrations are higher than their natural abundances respectively. The two isotopes are plated on the reaction chamber in different layers. In one embodiment, the different layers of the plated isotopes are of the same geometric pattern. In another embodiment, the different layers of the plated isotopes are of different geometric patterns. The different layers of the plated isotopes may be of the same or different thicknesses.

In some embodiments, an apparatus for generating excess heat in an exothermic reaction comprises a reaction chamber and a triggering device. The reaction chamber is plated with an enriched product of a transition metal. The reaction chamber contains a hydrogen gas. The triggering device is configured to trigger the exothermic reaction between the transition metal and the hydrogen gas. The enriched product comprises an isotope of the transition metal whose concentration is higher than the natural abundance of the isotope to enhance the exothermic reaction. In some embodiments, the transition metal may be nickel or palladium.

### BRIEF DESCRIPTION OF FIGURES

FIG. 1 illustrates an exemplary reactor for triggering and maintaining an exothermic reaction.

FIG. 2 is a table listing transition metal isotopes.

FIG. 3 is a chart illustrating the natural abundances of different palladium isotopes.

FIG. 4 (Tables 4A-4C) illustrates the target concentrations of various isotopes of Pd, in different embodiments.

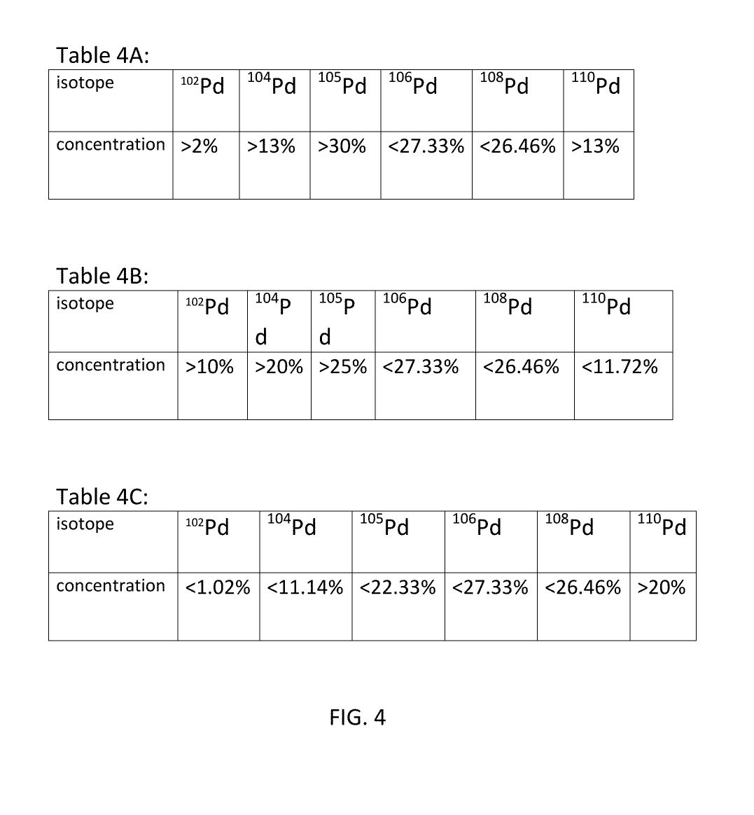

FIG. 5 is a chart illustrating the natural abundances of different nickel isotopes.

FIG. 6 (Tables 6A-6B) illustrates the target concentrations of various isotopes of Ni, in different embodiments.

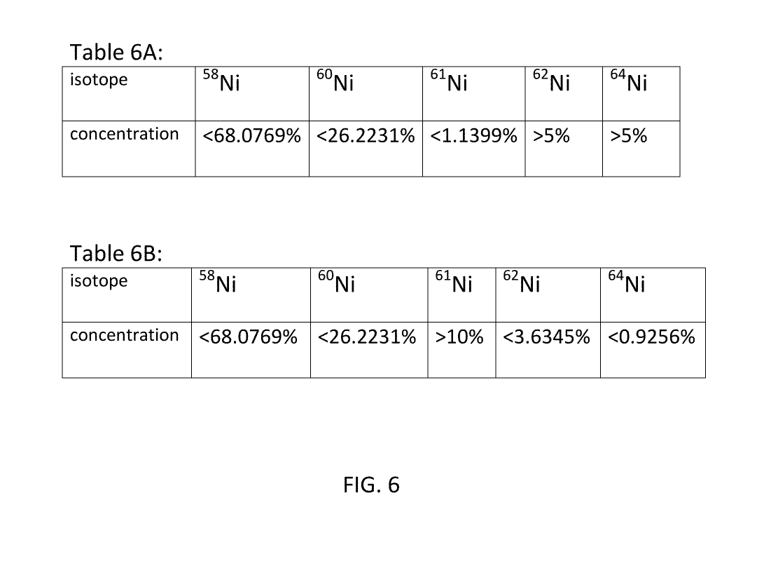

FIG. 7 is a chart illustrating the natural abundances of different zirconium isotopes.

FIG. 8 (Tables 8A-8C) illustrates the target concentrations of various isotopes of zirconium.

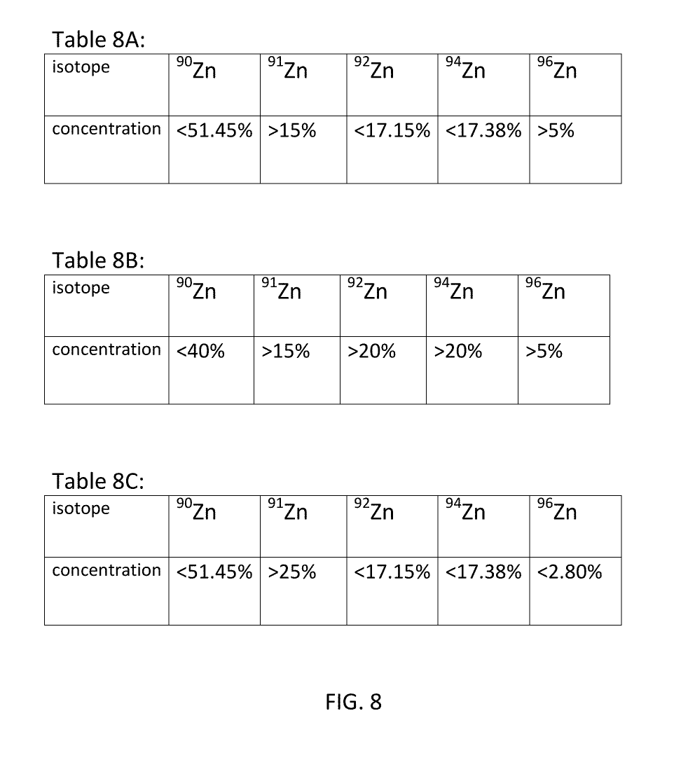

FIG. 9 is a chart illustrating the natural abundances of different ruthenium isotopes.

FIG. 10 (Tables 10A-10C) illustrates the target concentrations of various isotopes of ruthenium.

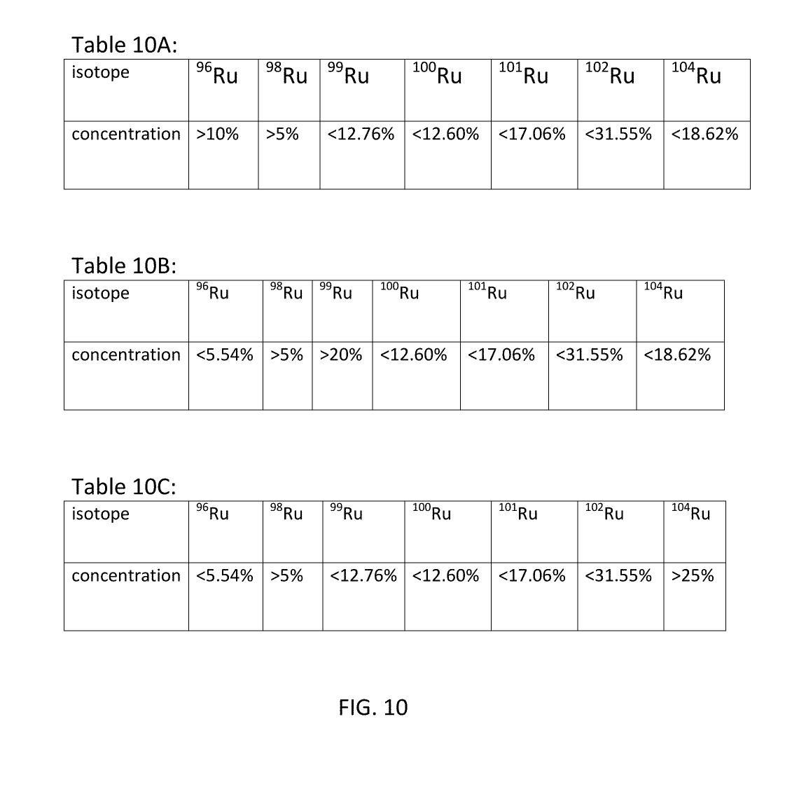

FIG. 11 illustrates an exemplary embodiment of plating enriched palladium or nickel to enhance anomalous heat generation in an exothermic heat generation.

FIG. 12 illustrates a second exemplary embodiment of plating enriched palladium or nickel to enhance anomalous heat generation in an exothermic heat generation.

FIG. 13 illustrates a tetragonal and cubic crystal structure.

### DETAILED DESCRIPTION

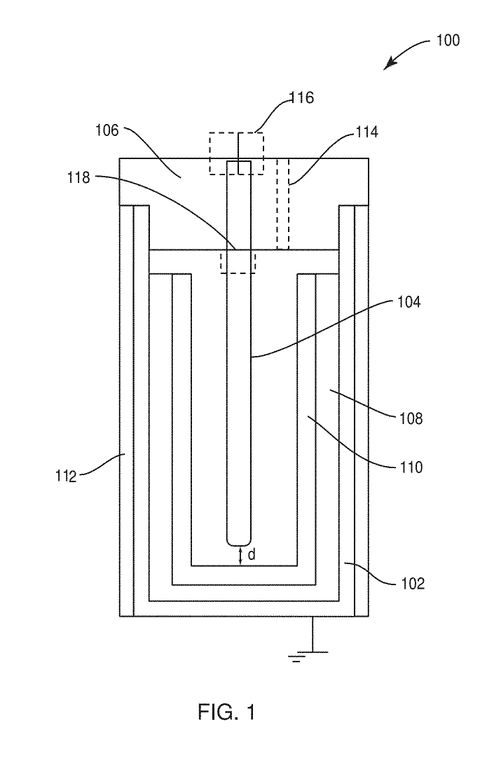

FIG. 1 illustrates an exothermic reaction chamber 100. The reaction chamber 100 comprises a metal container 102, an electrode 104, and a lid 106. The interior wall of the metal container 102 is first plated with gold 108 or another material (e.g., silver). The plated gold or silver functions as a seal to prevent reaction gases in the chamber from escaping through the wall of the reaction chamber 100. On top of the gold 108, a layer of hydrogen absorbing material 110 is plated. Outside the reaction chamber 100, a magnet 112 may be optionally placed.

In FIG. 1, the lid 106 is placed at one end of the reaction chamber 100 and is used to accommodate the electrode 104, input/output ports 114, and a removable electrical pass-through 116. The electrode 104 may be made of tungsten, molybdenum, cobalt, or nickel, or other rugged metal that can withstand high voltage and high temperature environment. On the electrode 104, a stripe of insulator 108, such as Teflon, may be coated on the electrode 104 to prevent discharges between the electrode 104 and the exposed (i.e., un-plated) area on the interior wall of the reaction chamber 100. The input/output ports 104 are used to introduce reaction gases into the reaction chamber 100 or extract resultant gases from the reaction chamber 100. The input/output ports 104 can also be used to accommodate pressure controlling devices.

In some embodiments, the device used for triggering an exothermic reaction comprises a metal container and an electrode. The electrode is received through an open end of the metal container. The electrode is plated with a hydrogen absorbing material. The electrode is first plated with a layer of gold and the hydrogen absorbing material is plated on top of the layer of gold. Examples of hydrogen absorbing materials include palladium, nickel, platinum, etc.

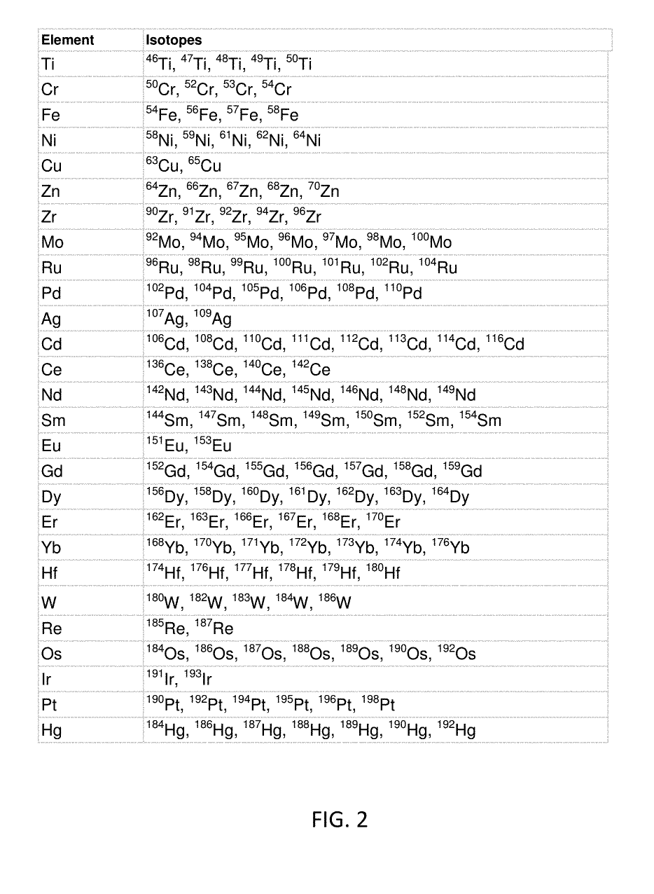

The present disclosure teaches methods and apparatus for increasing the efficacy of an exothermic reaction by selectively enriching one or more isotopes of the hydrogen absorbing material, e.g., a transition metal such as palladium. FIG. 2 is a table listing the naturally occurring stable isotopes of some transition metals that have large isotope distributions.

The stable isotope distributions for all transition metals are well known and documented. Although many factors—including vacancies, lattice defects, hydrogen or deuterium loading ratios, and dopants or contaminants in the Pd lattice—may be necessary for enhancing anomalous heat generation, it is believed that the isotope distribution in the Pd lattice is a critical factor in generation of anomalous heat, particularly at higher energy release levels. The methods disclosed herein relate to the deliberate and controlled modification of the isotope distribution of Pd from its natural distribution to levels necessary to generate or sustain more reliable and stronger anomalous heat generation.

In the research and tests surrounding anomalous heat generation in various physical configurations—e.g., wet cell, gas charged tubes, and dry reactors—have been investigated. A wet cell is an electrolytic cell containing water (may be light or heavy) and an electrolyte as well as solid reactant material, wherein a voltage/current is supplied. A dry reactor is a reactor in which solid reactants can be triggered. A gas-charged tube is a reactor in which solid reactant material in a chamber can be pressurized with a gas (usually H2 or D2) and triggered. In any of these configurations, many have suggested that generating and sustaining reactions is specifically related to three major contributing factors: 1. defects (specifically vacancies) in the Pd metallic lattice, 2. the deuterium and hydrogen loading levels (or ratios) into the Pd lattice, and, 3. dopants (or contaminants) in the lattice structure. There has been no known discussion regarding the specific modification of the isotope distribution as a precursor or means to enhance anomalous heat generation.

Many elemental materials have a broad range of both stable and unstable (radioactive) isotopes. There are many techniques used to separate or enhance specific isotope concentrations. However, application of modified isotope concentration levels of Pd to specifically enhance the generation of anomalous heat has not been considered. There is no known background information on enhancing the ratios of specific isotopes to levels substantially higher than their natural levels to make anomalous heat generation more reliable, robust, and/or durable. Techniques for enriching particular isotopes in naturally occurring elements are widely known. The most prevalent is the enrichment of uranium 235 (radioactive uranium) using centrifuge technologies. Uranium is known to have naturally occurring abundances of U238 99.27%, U235 0.72%, and U234 of 0.0055%. Most commercial and military nuclear reactions are based on exploitation of U235 in concentrations substantially above its naturally occurring levels. These applications require uranium with concentrations of 15% to greater than 60% U235 to be viable. The most effective and prevalent technique for enriching uranium is the use of centrifuges. This technology relies on dissolving the uranium feedstock using a chemical solvent and then passing the feed material through a centrifuge system to remove higher concentration U235.

This type of technique has not been explored with respect to Pd isotope concentrations.

In existing systems and tests—including heavy water electrolytic cells, heavy water codeposition electrolytic cells, Pd lattice plated devices with hydrogen and deuterium gas, and solid state reactors—the created or used Pd lattice is based on use of commercially available solutions and/or materials. These solutions and/or materials are often palladium chloride or other solutions or solids from which a film is created using electrolysis, Physical Vapor Deposition, or Chemical Vapor Deposition. In some instances the material is an industrial Pd powder or plate. The precise isotope concentrations in the solutions or solids are not known, documented, or controlled. It is assumed that the isotope concentrations are at naturally occurring levels. However, the inconsistent efficacy of anomalous heat generation is a persistent result of these systems and tests. The exact concentrations of the Pd isotopes are controlled by specifically enriching certain isotopes above their naturally occurring levels.

The objective is to increase the efficacy of anomalous heat generation by controlling the isotope levels in the reactors by enriching specific isotopes above the naturally occurring levels. The concentration levels of ¹⁰²Pd, ¹⁰⁴Pd, ¹⁰⁵Pd, ¹¹⁰Pd to levels higher than their naturally occurring levels supports the generation of robust levels of anomalous heat, more effective control of the reaction, and enhances the durability of the reaction. Various techniques for isotope level modifications are used to achieve the enhancements of the noted isotopes to a minimum level above the natural levels. The primary technique for enhancing the concentrations is the use of a centrifuge using a Pd feedstock that is chemically dissolved.

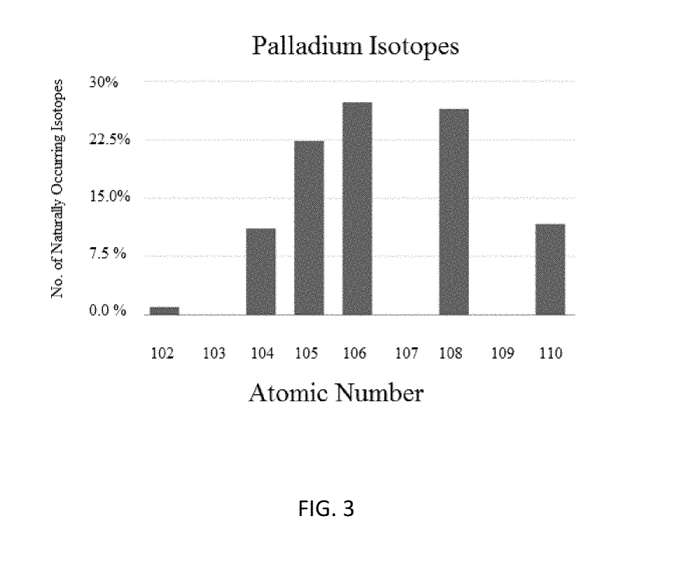

In some embodiments, a centrifuge or equivalent mechanical techniques is used to enrich the levels of ¹⁰²Pd, ¹⁰⁴Pd, ¹⁰⁵Pd, ¹¹⁰Pd to levels higher than their naturally occurring levels, while proportionally reducing the levels of ¹⁰⁶Pd and ¹⁰⁸ Pd. The raw Pd stock is dissolved using a chemical solvent to break the metal at the atomic level to create feedstock. The feedstock target constituents are enriched via a centrifuge that is designed to specifically enrich Pd and not to fully separate the various isotopes from the system. FIG. 3 shows the natural distribution of Pd. This distribution is accepted as the expected distribution of Pd in a sample of naturally occurring Pd.

In some embodiments, the concentration of one or more of the four least common isotopes is achieved to enhance the efficacy of the anomalous heat generation. By enriching one or more of the four isotopes the concentrations of the other isotopes are inherently reduced. Tables 4A-4C show the isotopes that are targeted for enrichment, and the targeted concentration/dilution of each for different embodiments.

Subsequent to enrichment the enriched Pd feedstock will be reversed into Pd metal plate, stock, or powder to support creation of the necessary materials for generation of anomalous heat.

This approach can be achieved by using a centrifuge or other technique to enrich the four least common isotopes, ¹⁰²Pd, ¹⁰⁴Pd, ¹⁰⁶Pd, and ¹¹⁰Pd, which are necessary to enhance anomalous heat generation by drawing off feedstock from the centrifuge such that one or more of the four isotopes are extracted in higher concentration. It is equivalent to use a centrifuge to reduce the concentration of ¹⁰⁶Pd and ¹⁰⁸Pd. The objective is to reduce the concentration of ¹⁰⁶Pd and ¹⁰⁸Pd while enhancing the concentration of the rarer four isotopes ¹⁰²Pd, ¹⁰⁴Pd, ¹⁰⁵Pd and ¹¹⁰Pd.

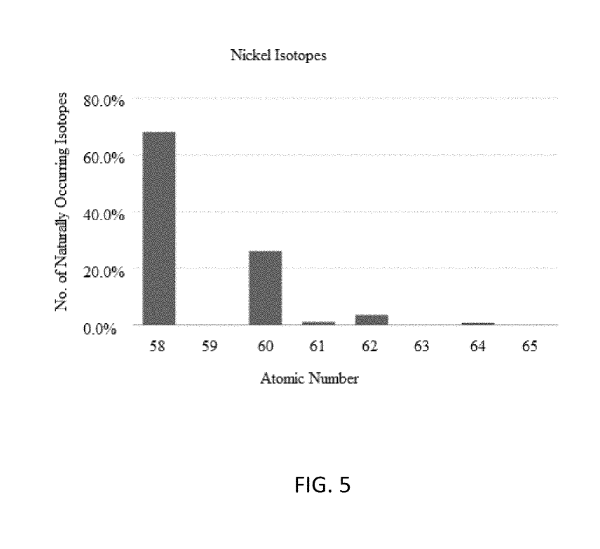

This same technique can be used with nickel-based anomalous heat generation. Using nickel requires the enrichment of one or more of ⁶¹Ni, ⁶²Ni, and ⁶⁴Ni isotopes while reducing the relative concentrations of ⁵⁸Ni or ⁶⁰Ni. Nickel isotopes are shown in FIG. 5. Tables 6A and 6B show the isotopes that are targeted for enrichment, and the targeted concentration/dilution of each for different embodiments.

This same technique can be used with any transition-metal based anomalous heat generation, for example, zirconium or ruthenium based excess heat generation.

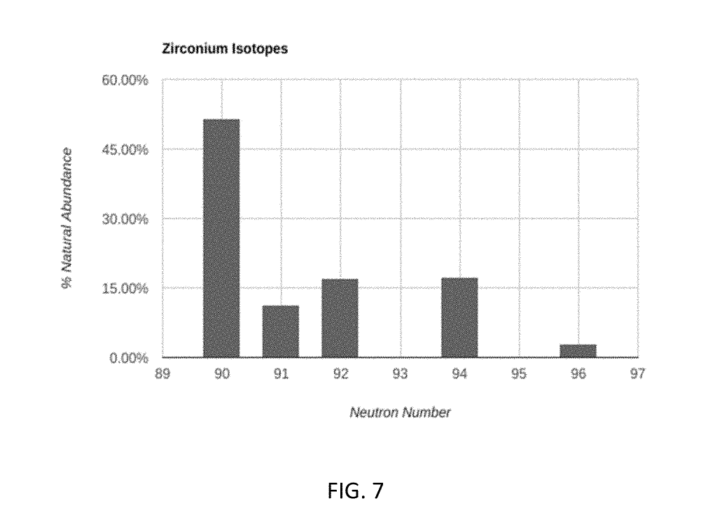

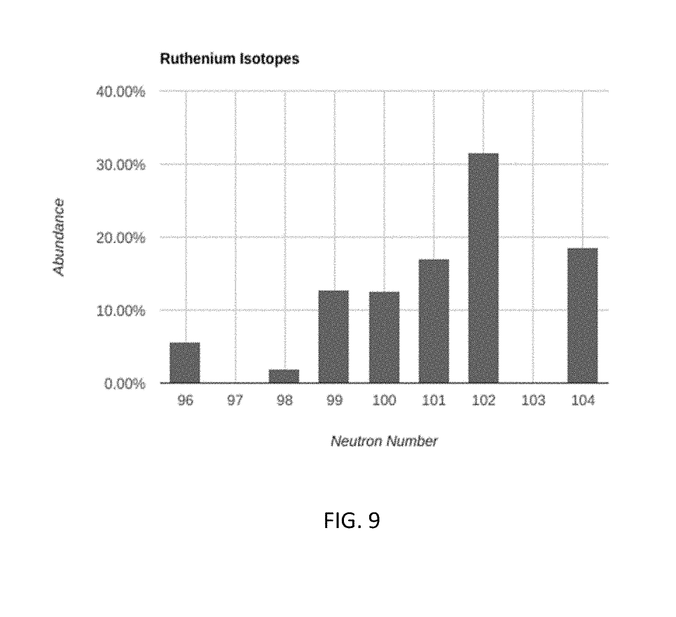

FIG. 7 illustrates the natural abundances of different isotopes for zirconium. Tables 8A-8C show the isotopes that are targeted for enrichment, and the targeted concentration/dilution of each for different embodiments. FIG. 9 illustrates the natural abundances of different isotopes for ruthenium. Tables 10A-10C show the isotopes that are targeted for enrichment, and the targeted concentration/dilution of each for different embodiments.

It is also possible to generate higher concentrations of certain Pd, Ni, Zr, and Ru isotopes using rapid expansion of the metals as is common for metal foam production or spin casting. Using highly optimized foam metal fabrication techniques or spin casting techniques, specific regions of the foam or spin cast materials have higher concentrations of particular isotopes based on the relative momentum of each isotope when cast. This would require measuring the materials after fabrication to extract the region with the appropriate isotope concentrations. This is applicable to Pd, Ni, Zr, and Ru.

The enrichment of isotopes supports accentuating specific design features of the system. The following examples are the preferred embodiments for the configurations.

Table 4A: Enrich ¹⁰⁵Pd to a minimum of 30% enrichment, ¹⁰²Pd to a minimum of 2% enrichment, ¹⁰⁴Pd to a minimum of 13% enrichment, and ¹¹⁰Pd to a minimum of 13% enrichment while allowing ¹⁰⁶Pd and ¹⁰⁸Pd to reduce proportionally.

Table 4B: Enrich ¹⁰²Pd to a minimum of 10% enrichment, ¹⁰⁴Pd to 20% enrichment, ¹⁰⁵Pd to a minimum of 25% enrichment, while allowing ¹⁰⁶Pd, ¹⁰⁸Pd, and ¹¹⁰Pd to reduce proportionally.

Table 4C: Enrich ¹¹⁰Pd to a minimum of 20% enrichment while allowing ¹⁰²Pd, ¹⁰⁴Pd, ¹⁰⁵Pd, ¹⁰⁶Pd, and ¹⁰⁸Pd to reduce proportionally.

The preferred embodiment of the Nickel Isotope Enrichment follows:

Table 6A: Enrich the ⁶¹Ni to a minimum of 5% enrichment, ⁶²Ni to a minimum of 5% enrichment, and ⁶⁴Ni to a minimum of 5% enrichment while allowing ⁵⁸Ni and ⁶⁰Ni to reduce proportionally.

Table 6B: Enrich ⁶¹Ni to a minimum of 10% enrichment while allowing ⁶²Ni, ⁶⁴Ni, ⁵⁸Ni and ⁶⁰Ni to reduce proportionally.

The preferred embodiments for zirconium isotopes are shown in Tables 8A-8C.

In Table 8A, ⁹¹Zr is enriched to a minimum of 15% and ⁹⁶Zr is enriched to a minimum of 5%, while allowing ⁹⁰Zr, ⁹²Zr, and ⁹⁴Zr to be reduced proportionally,

In Table 8B, ⁹¹Zr is enriched to a minimum of 15%, ⁹²Zr is enriched to a minimum of 20%, ⁹⁴Zr is enriched to a minimum of 20%, and ⁹⁶Zr is enriched to a

In Table 8C, ⁹¹Zr is enriched to a minimum of 25%, while allowing ⁹⁰Zr, ⁹²Zr, ⁹⁴Zr, and ⁹⁶Zr to be reduced proportionally.

The preferred embodiments for ruthenium isotopes are shown in Tables 10A-10C.

In Table 10A, ⁹⁶Ru is enriched to a minimum of 10%, ⁹⁸Ru is enriched to a minimum of 5%, while allowing ⁹⁹Ru, ¹⁰⁰Ru, ¹⁰¹Ru, ¹⁰²Ru, and ¹⁰⁴Ru to be reduced proportionally.

In Table 10B, ⁹⁹Ru and ¹⁰¹Ru are enriched to a minimum of 20% each, while allowing ⁹⁶Ru, ⁹⁸Ru, ¹⁰⁰Ru, and ¹⁰¹Ru to be reduced proportionally.

In Table 10C, ¹⁰⁴Ru is reduced to a minimum of 25%, while allowing ⁹⁶Ru, ⁹⁸Ru, ⁹⁹Ru, ¹⁰⁰Ru, ¹⁰¹Ru, and ¹⁰²Ru to be reduced proportionally.

Other factors to consider:

There could be many other variations of techniques for isotope enrichment for Pd, Ni, Zr, and Ru. There is the potential for foam, spin casting, or creating a plating technique where PVD or CVD technique is modified to enhance certain isotopes.

There could be enhancements to the alloy by including some of the other related materials in the alloy, e.g., palladium with rhodium and silver, and nickel with cobalt and copper.

Alloying Pd, Ni, Zr, and Ru each with higher concentrations should be considered as a method to control cost due to the abundance of various materials.

An application of these material configurations is to use the enriched isotopes, or alternatively pure isotopes, of Pd and Ni as the building block for PVD and CVD device coating. By creating Pd isotope enriched and Ni isotope enriched targets, or pure Pd or pure Ni isotope targets, for PVD and CVD individual layers of the specific isotopes.

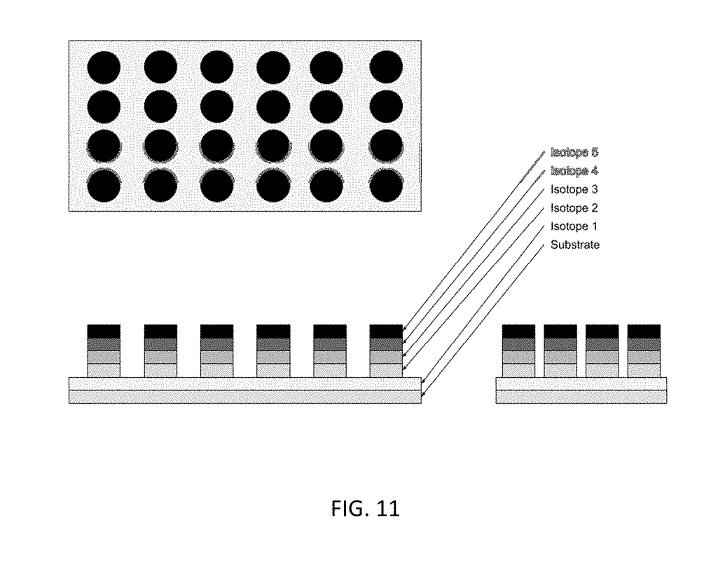

Using pure isotopes of Pd and Ni, complex geometric structures with stratified layers of isotopes can be constructed. FIG. 11 shows an example of a multiple isotope configuration built on a substrate.

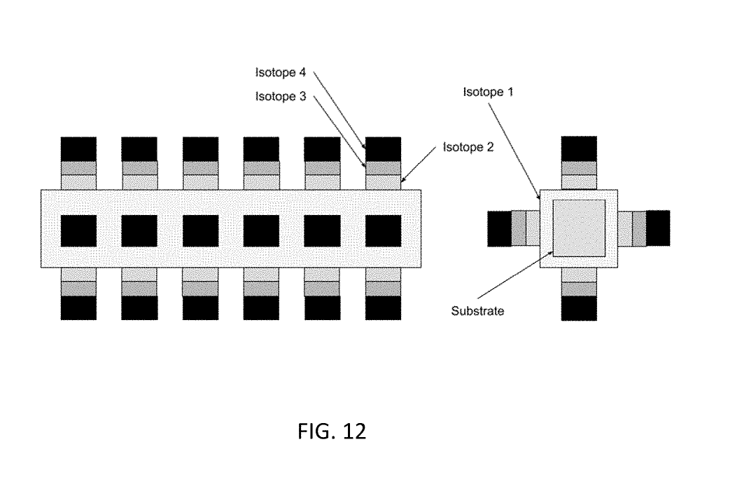

In this embodiment a single layer of Isotope 1 is placed on the substrate material via CVD or PVD technology. Subsequently, layers of Isotopes are placed in a geometric array in a pattern on the surface. In this embodiment a configuration with cylindrical geometry isotopes stacked vertically above the base isotope that is layered on the substrate is depicted. A wide range of isotope stack geometries is feasible including cylinder, square, rectangle, and pyramid. This geometry is controlled by the sputter mask in the PVD or CVD system. The thickness of each isotope and the number of isotopes can be varied in the PVD or CVD process. The substrate material can be a rigid flat surface such that the system can be used as manufactured. Alternatively the substrate can be a very thin film such that it can be bent or shaped into various configurations. Alternatively the substrate can be a complex geometry such as a cylinder, square, or other geometry as shown in FIG. 12.

In this embodiment a square substrate material is coated by Isotope 1 and then place an array of square geometry stacks of various thicknesses and on each of the surfaces.

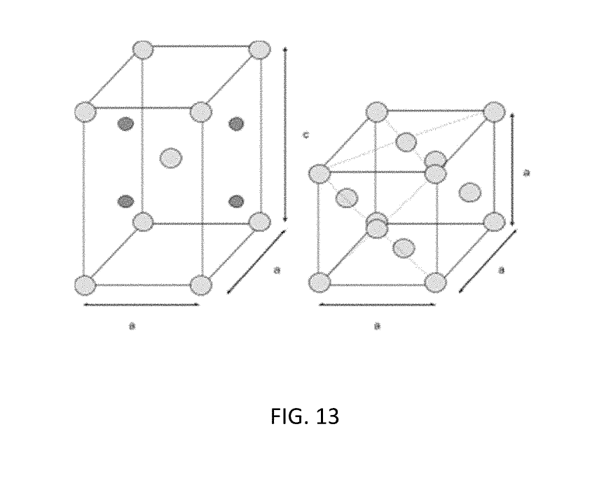

In one embodiment, the isotope structure can be oxidized under specified conditions (i.e. time, temperature, atmosphere) to create an oxide of the enriched transition metal isotope with a crystal structure different than that of the base metal. The oxide can be used as the fuel for an exothermic reaction. When exposed to hydrogen or deuterium gas, the oxide is reduced to the base metal. During the reduction, when the lattice structure changes from for example tetragonal to cubic crystal structure (see FIG. 13), heat and significant defects are generated. This provides a suitable environment for anomalous heat generation reactions to occur.

In another embodiment, a metal isotope with a relatively high reduction potential is oxidized under specific conditions to create an enriched oxide. This oxide is used in conjunction with either another enriched oxide of a lower reduction potential or another enriched/non-enriched reactant, e.g. palladium or nickel. The oxide of high reduction potential can provide support if using nanoparticle reactants and/or can be a catalyst for the reaction.

The invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of enhancing an exothermic reaction between a hydrogen gas and a transition metal, the exothermic reaction occurring in a reaction chamber, said method comprising:
plating the reaction chamber with an enriched product of the transition metal, said enriched product comprising an isotope of the transition metal, wherein the concentration of the isotope in the enriched product being higher than a natural abundance of the isotope;
wherein, inside the reaction chamber, the exothermic reaction between the hydrogen gas and the enriched product is triggered and sustained.

2. The method of claim 1, wherein the hydrogen gas comprises deuterium.

3. The method of claim 1, wherein the transition metal is one of nickel, palladium, zirconium, and ruthenium.

4. The method of claim 3, wherein the transition metal is palladium and the isotope is one of ¹⁰²Pd, ¹⁰⁴Pd, ¹⁰⁵Pd, and ¹¹⁰Pd.

5. The method of claim 4, wherein the isotope is ¹⁰⁵Pd and the concentration of ¹⁰⁵Pd is higher than or equal to 25%.

6. The method of claim 3, wherein the transition metal is nickel and the isotope is one of ⁵⁸Ni, ⁶⁰Ni, ⁶¹Ni, ⁶²Ni, and ⁶⁴Ni.

7. The method of claim 6, wherein the isotope is ⁶¹Ni and the concentration of ⁶¹Ni is higher than or equal to 5%.

8. The method of claim 1, wherein the high concentration of the isotope in the enriched product is achieved via one of the following isotope enrichment techniques: centrifugal separation, foam fabrication, electromagnetic calutron, laser separation, and spin casting.

9. The method of claim 3, wherein the enriched product further comprises a second metal.

10. The method of claim 9, wherein the transition metal is palladium and the second metal is rhodium or silver.

11. The method of claim 9, wherein the transition metal is nickel and the second metal is cobalt or copper.

12. The method of claim 9, wherein the transition metal is palladium and the second metal is nickel and wherein the second metal comprises a nickel isotope, the concentration of the nickel isotope being higher than a natural abundance of the nickel isotope.

13. The method of claim 1, wherein the enriched product of the transition metal comprises a single isotope of the transition metal.

14. The method of claim 1, wherein the enriched product of the transition metal comprises a second isotope of the transition metal, the concentration of the second isotope of the transition metal being higher than the natural abundance of the second isotope.

15. The method of claim 14, wherein the reaction chamber is plated with two or more isotopes of the transition metal and wherein the plating of the reaction chamber comprises:
plating a first layer of the transition metal, wherein the first layer comprises a first isotope of the transition metal; and
plating a second layer of the transition metal, wherein the second layer comprises a second isotope of the transition metal.

16. The method of claim 15, wherein the first layer and the second layer are of a same geometric pattern.

17. The method of claim 15, wherein the first layer and the second layer are of different geometric patterns.

18. The method of claim 15, wherein the first layer and the second layer are of different thicknesses.

19. An apparatus for generating excess heat in an exothermic reaction, said apparatus comprising:
a reaction chamber, said reaction chamber plated with an enriched product of a transition metal and containing a hydrogen gas; and
a triggering device configured to trigger the exothermic reaction between the transition metal and the hydrogen gas inside the reaction chamber;
wherein the enriched product comprises an isotope of the transition metal, and wherein the concentration of the isotope in the enriched product is higher than the natural abundance of the isotope, to enhance the exothermic reaction.

20. The apparatus of claim 19, wherein the hydrogen gas comprises deuterium.

21. The apparatus of claim 19, wherein the transition metal is one of nickel, palladium, zirconium, and ruthenium.

22. The apparatus of claim 21, wherein the transition metal is palladium and the isotope is one of ¹⁰²Pd, ¹⁰⁴Pd, ¹⁰⁵Pd, and ¹¹⁰Pd.

23. The apparatus of claim 22, wherein the isotope is ¹⁰⁵Pd and the concentration of ¹⁰⁵Pd is higher than or equal to 25%.

24. The apparatus of claim 21, wherein the transition metal is nickel and the isotope is one of ⁵⁸Ni, ⁶⁰Ni, ⁶¹Ni, ⁶²Ni, and ⁶⁴Ni.

25. The apparatus of claim 24, wherein the isotope is ⁶¹Ni and the concentration of ⁶¹Ni is higher than or equal to 5%.

26. The apparatus of claim 19, wherein the transition metal is a plated palladium that comprises two or more layers and wherein each of the two or more layers comprise one isotope of the transition metal.

27. The apparatus of claim 26, wherein the two or more layers of the plated palladium are of a same geometric pattern.

28. The apparatus of claim 26, wherein the two or more layers of the plated palladium are of different geometric patterns.

29. The apparatus of claim 26, wherein the two or more layers of the plated palladium are of different thicknesses.
